(19) United States
(12) Patent Application Publication
(10) Pub. No.: US 2018/0278391 A1
(43) Pub. Date: Sep. 27, 2018

(54) USER EQUIPMENT, BASE STATION AND RELATED METHOD THEREFOR

(71) Applicant: SHARP KABUSHIKI KAISHA, Sakai City, Osaka (JP)

(72) Inventors: MENG ZHANG, Shanghai (CN); XINGYA SHEN, Shanghai (CN); RENMAO LIU, Shanghai (CN)

(21) Appl. No.: 15/761,894

(22) PCT Filed: Sep. 13, 2016
(86) PCT No.: PCT/CN2016/098825

§ 371 Date: Mar. 21, 2018

(30) Foreign Application Priority Data
Sep. 25, 2015 (CN) 201510623258.1

(51) Int. Cl. H04L 5/00; H04W 72/04

(52) U.S. Cl. CPC H04L 5/0048; H04W 72/042

(57) ABSTRACT

The present invention provides a method for use in a base station for indicating to a UE a demodulation reference signal (DMRS) configuration, the method comprising: generating first DMRS configuration information associated with a first physical downlink shared channel (PDSCH) for the UE; generating second DMRS configuration information associated with a second PDSCH for another UE, the second PDSCH overlapping with the first PDSCH; and sending to the UE the first DMRS configuration information and the second DMRS configuration information.

### TECHNICAL FIELD

The present invention relates to the technical field of wireless communication, and in particularly, to a User Equipment (UE), a base station, and a related method therefor.

### BACKGROUND

Modern wireless mobile communication systems present two significant features. One is high-speed broadband; for example, the fourth generation wireless mobile communication system has a bandwidth of up to 100 MHz and a downlink speed of up to 1 Gbps. The other feature is mobile interconnection, which promotes emerging services, such as WAP, mobile phone video-on-demand, online navigation and the like. These two features bring higher requirements for wireless mobile communication technology. Such requirements mainly include: ultrahigh-speed wireless transmission, inter-region interference suppression, mobile reliable signal transmission, distributed/centralized signal processing and the like. To meet the development requirements above, various corresponding key technologies begin to be proposed and demonstrated in the future enhanced Fourth Generation (4G) or Fifth Generation (5G) wireless mobile communication system. Such a trend deserves great attention of researchers in the field.

In October 2007, the International Telecommunication Union (ITU) approved the Worldwide Interoperability for Microwave Access (WiMAX) as the fourth Third Generation (3G) system standard. This event, which occurred at the end of the 3G era, is actually a preview of the 4G standard battle. In fact, in response to the challenge of streams of wireless Internet Protocol (IP) technologies represented by Wireless Local Area Network (WLAN) and WiMax, the 3rd Generation Partnership Project (3GPP) organization has embarked on a completely new system upgrade, i.e., standardization of Long Term Evolution (LTE) since 2005. This is a quasi-fourth-generation system based on Orthogonal Frequency Division Multiplexing (OFDM) which was first released in early 2009 and started to be commercially available globally in 2010. Meanwhile, the 3GPP organization also has launched the standardization of the Fourth Generation (4G) wireless mobile communication system in the first half of 2008. The system is called a Long Term Evolution Advanced (LTE-A) system. The key standardized document for the physical layer process of the system was completed in early 2011. In November 2011, the ITU organization officially announced in Chongqing, China, that LTE-A systems and WiMax systems are two official standards for 4G systems. At present, the commercial process of LTE-A systems is being gradually expanded worldwide.

According to the challenges in the next 10 years, the following several development requirements exist for the enhanced fourth generation wireless mobile communication system:
a higher wireless broadband rate with a focus on optimizing a localized cell hot-spot area;
further improving the user experience with a particular need to optimize communication services in the border area of a cell;
a need to continue studying new technology capable of improving the utilization efficiency of a spectrum, considering that an available spectrum cannot be expanded 1000 times;
high frequency spectra (5 GHz or higher) must be put into use to obtain larger communication bandwidths;
collaborative work of existing networks (2G/3G/4G, WLAN, WiMax, etc.) to share data traffic;
dedicated optimization for different businesses, applications, and services;
strengthening the system's ability to support large-scale machine communication;
flexible, intelligent and inexpensive network planning and network distribution;
designing a solution to save network power consumption and user equipment battery consumption.

In the conventional 3GPP LTE system, multiple pieces of user data can be transmitted over a single data stream, which is commonly referred to as multi-user (MU) transmission technology. However, the traditional MU technology can obtain better performance only when the user's channels are as orthogonal as possible, which limits the flexibility of user scheduling to a certain extent. To this end, the 3GPP RAN #67 plenary discussed a new research topic, i.e., the study of Multi-user Superposition Transmission (MUST), the main purpose of which is to study the function of transmitting multiple pieces of user information through single-stream data in an overlapping and superimposed manner by adjusting the power of multiple user-modulated signals. Compared with the traditional MU technology, the MUST technology does not require orthogonality between channels from the UE to the base station. Therefore, with the use of the MUST technology, the base station can schedule the UE more flexibly. Currently, Release 13 specifies MUST technology through which every data stream supports only two UEs.

Currently, if two UEs that employ MUST use different precoding matrices, a UE on which interference cancellation needs to be performed needs to estimate not only a Physical Downlink Shared Channel (PDSCH) between the UE and the base station, but also a PDSCH channel overlapping with the foregoing PDSCH and on which interference cancellation needs to be performed. Particularly, in some Transmission Modes (TMs) based on a Demodulation Reference Signal (DMRS), such as TM9 and TM10, a UE on which interference cancellation needs to be performed in the MUST mode needs to know which DMRSs may be used to estimate a PDSCH between the UE and the base station, and which DMRSs may be used to estimate a PDSCH channeloverlapping with the foregoing PDSCH and on which interference cancellation needs to be performed.

Therefore, the UE needs to know DMRS configurations associated with its own PDSCH and its PDSCH on which interference cancellation needs to be performed.

### SUMMARY

An object of the present invention is to provide a user equipment, a base station and a related method therefor which enables the UE to know DMRS configurations associated with its own PDSCH and its PDSCH on which interference cancellation needs to be performed.

According to a first aspect of the present invention, a method for use in a base station for indicating to a UE a DMRS configuration is provided, the method comprising: generating first DMRS configuration information associated with a first PDSCH for the UE; generating second DMRS configuration information associated with a second PDSCH for another UE, the second PDSCH overlapping with the first PDSCH; and sending to the UE the first DMRS configuration information and the second DMRS configuration information.

In the embodiment, the first DMRS configuration information and the second DMRS configuration information are sent in DCI.

In the embodiment, the first DMRS configuration information and the second DMRS configuration information are comprised in a field of “Ports Scrambling Code Identification Number of Layers (Ports-SCID-Number of Layers)” of the DCI.

In the embodiment, the first DMRS configuration information indicates an antenna port related to the first PDSCH; and the second DMRS configuration information indicates an antenna port related to the second PDSCH.

In the embodiment, the first DMRS configuration information further indicates a first DMRS sequence related to the first PDSCH; and the second DMRS configuration information further indicates a second DMRS sequence related to the second PDSCH.

In the embodiment, the antenna port related to the first PDSCH and the antenna port related to the second PDSCH are indicated in a bitmap format.

In the embodiment, the first DMRS configuration information comprises an indicator regarding a first plurality of antenna port groups related to the first DMRS configuration information sent in Radio Resource Control (RRC) signaling, and an indicator regarding an antenna port group related to the first PDSCH in the first plurality of antenna port groups sent in the DCI; and the second DMRS configuration information comprises an indicator regarding a second plurality of antenna port groups related to the second DMRS configuration information sent in the RRC signaling, and an indicator regarding an antenna port group related to the second PDSCH in the second plurality of antenna port groups sent in the DCI.

According to a second aspect of the present invention, a base station for indicating to a UE a DMRS configuration is provided, the base station comprising: a generating unit, used for generating first DMRS configuration information associated with a first PDSCH for the UE, and generating second DMRS configuration information associated with a second PDSCH for another UE, the second PDSCH overlapping with the first PDSCH; and a sending unit, used for sending to the UE the first DMRS configuration information and the second DMRS configuration information.

In the embodiment, the first DMRS configuration information and the second DMRS configuration information are sent in DCI.

In the embodiment, the first DMRS configuration information and the second DMRS configuration information are comprised in a field of “Ports-SCID-Number of Layers” of the DCI.

In the embodiment, the first DMRS configuration information indicates an antenna port related to the first PDSCH; and the second DMRS configuration information indicates an antenna port related to the second PDSCH.

In the embodiment, the first DMRS configuration information further indicates a first DMRS sequence related to the first PDSCH; and the second DMRS configuration information further indicates a second DMRS sequence related to the second PDSCH.

In the embodiment, the antenna port related to the first PDSCH and the antenna port related to the second PDSCH are indicated in a bitmap format.

In the embodiment, the first DMRS configuration information comprises an indicator regarding a first plurality of antenna port groups related to the first DMRS configuration information sent in RRC signaling; and an indicator regarding an antenna port group related to the first PDSCH in the first plurality of antenna port groups sent in the DCI; and the second DMRS configuration information comprises an indicator regarding a second plurality of antenna port groups related to the second DMRS configuration information sent in the RRC signaling, and an indicator regarding an antenna port group related to the second PDSCH in the second plurality of antenna port groups sent in the DCI.

According to a third aspect of the present invention, a method for use in a UE for acquiring a DMRS configuration is provided, the method comprising: receiving, from a base station, first DMRS configuration information associated with a first PDSCH for the UE; and receiving, from the base station, second DMRS configuration information associated with a second PDSCH for another UE, the second PDSCH overlapping with the first PDSCH.

In the embodiment, the first DMRS configuration information and the second DMRS configuration information are received in DCI.

In the embodiment, the first DMRS configuration information and the second DMRS configuration information are comprised in a field of “Ports-SCID-Number of Layers” of the DCI.

In the embodiment, the first DMRS configuration information indicates an antenna port related to the first PDSCH; and the second DMRS configuration information indicates an antenna port related to the second PDSCH.

In the embodiment, the first DMRS configuration information further indicates a first DMRS sequence related to the first PDSCH; and the second DMRS configuration information further indicates a second DMRS sequence related to the second PDSCH.

In the embodiment, the antenna port related to the first PDSCH and the antenna port related to the second PDSCH are indicated in a bitmap format.

In the embodiment, the first DMRS configuration information comprises an indicator regarding a first plurality of antenna port groups related to the first DMRS configuration information sent in RRC signaling, and an indicator regarding an antenna port group related to the first PDSCH in the first plurality of antenna port groups sent in the DCI; and the second DMRS configuration information comprises an indicator regarding a second plurality of antenna port groups related to the second DMRS configuration information sent in the RRC signaling, and an indicator regarding an antenna port group related to the second PDSCH in the second plurality of antenna port groups sent in the DCI.

According to a fourth aspect of the present invention, a UE for acquiring a DMRS configuration is provided, comprising: a receiving unit, configured to receive, from a base station, first DMRS configuration information associated with a first PDSCH for the UE; and receive, from the base station, second DMRS configuration information associated with a second PDSCH for another UE, the second PDSCH overlapping with the first PDSCH.

In the embodiment, the first DMRS configuration information and the second DMRS configuration information are received in DCI.

In the embodiment, the first DMRS configuration information and the second DMRS configuration information are comprised in a field of “Ports-SCID-Number of Layers” of the DCI.

In the embodiment, the first DMRS configuration information indicates an antenna port related to the first PDSCH; and the second DMRS configuration information indicates an antenna port related to the second PDSCH.

In the embodiment, the first DMRS configuration information further indicates a first DMRS sequence related to the first PDSCH; and the second DMRS configuration information further indicates a second DMRS sequence related to the second PDSCH.

In the embodiment, the antenna port related to the first PDSCH and the antenna port related to the second PDSCH are indicated in a bitmap format.

In the embodiment, the first DMRS configuration information comprises an indicator regarding a first plurality of antenna port groups related to the first DMRS configuration information sent in RRC) signaling, and an indicator regarding an antenna port group related to the first PDSCH in the first plurality of antenna port groups sent in the DCI; and the second DMRS configuration information comprises an indicator regarding a second plurality of antenna port groups related to the second DMRS configuration information sent in the RRC signaling, and an indicator regarding an antenna port group related to the second PDSCH in the second plurality of antenna port groups sent in the DCI.

According to the embodiment of the present invention, the base station generates the first DMRS configuration information associated with the first PDSCH for the UE and the second DMRS configuration information associated with the second PDSCH for another UE and the second PDSCH overlaps with the first PDSCH; and sends to the UE the first DMRS configuration information and the second DMRS configuration information. Therefore, the UE is enabled to know DMRS configurations associated with its own PDSCH and its PDSCH on which interference cancellation needs to be performed.

### DESCRIPTION OF THE DRAWINGS

From preferred embodiments of the present invention described below in conjunction with the drawings, the above-mentioned objects and other features and advantages of the present invention will be better presented.

FIG. 1 is a block diagram of a UE according to an embodiment of the present invention;

FIG. 2 is a flowchart of a method for use in the UE according to an embodiment of the present invention;

FIG. 3 is a block diagram of a base station according to an embodiment of the present invention; and

FIG. 4 is a flowchart of a method for use in the base station according to an embodiment of the present invention.

### DESCRIPTION OF THE EMBODIMENTS

Embodiments of the present invention will be described in detail in conjunction with the drawings and specific embodiments. It is to be noted that the present invention shall not be limited to the specific embodiments described below. In addition, detailed descriptions of well-known technologies that are not directly related to the present invention are omitted for the sake of brevity, in order to avoid any confusion in understanding the present invention.

Multiple embodiments according to the present invention are specifically described in example application environments of an LTE mobile communication system and its subsequent evolved versions. However, it is to be noted that the present invention is not limited to the following embodiments, but may be applied to other wireless communication systems, such as a future 5G cellular communication system.

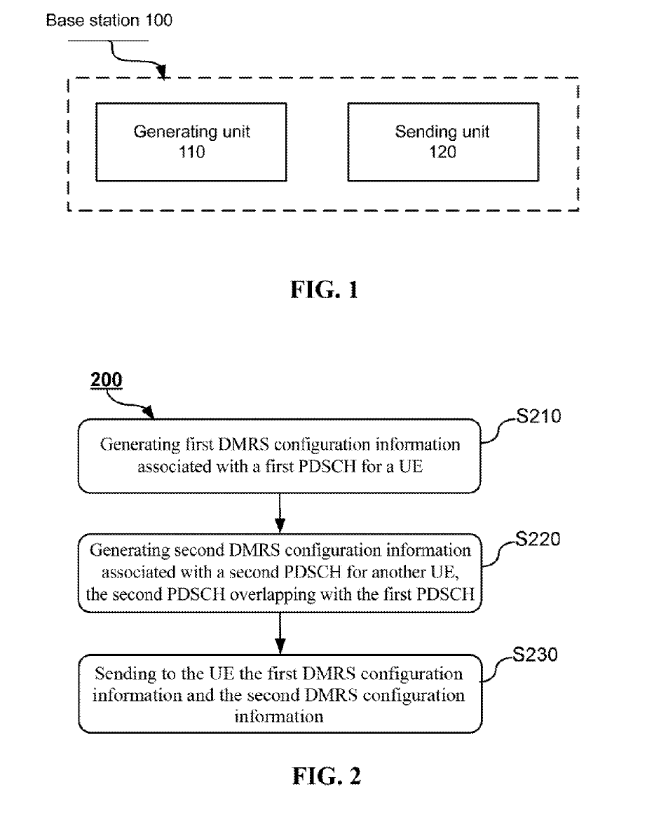

FIG. 1 illustrates a block diagram of a base station 100 according to an embodiment of the present invention. As shown in the figure, the base station 100 comprises a generating unit 110 and a sending unit 120. One skilled in the art will understand that the base station 100 further comprises other function units necessary to realize functions thereof, such as various processors, memories, and the like.

The generating unit 110 generates first DMRS configuration information associated with a first PDSCH for the UE, and generates second DMRS configuration information associated with a second PDSCH for another UE, the second PDSCH overlapping with the first PDSCH.

Herein, the second PDSCH of another UE overlaps with the first PDSCH. In other words, the second PDSCH is a PDSCH for the UE on which interference cancellation needs to be performed.

The sending unit 120 sends to the UE the first DMRS configuration information and the second DMRS configuration information.

In the embodiment, the first DMRS configuration information and the second DMRS configuration information are sent in DCI.

In one example, the first DMRS configuration information and the second DMRS configuration information are comprised included in a field “Ports-SCID-Number of Layers” of the DCI. The first DMRS configuration information indicates an antenna port (layer) related to the first PDSCH. The second DMRS configuration information indicates an antenna port (layer) related to the second PDSCH.

Optionally, the first DMRS configuration information further indicates a first DMRS sequence related to the first PDSCH; and the second DMRS configuration information further indicates a second DMRS sequence related to the second PDSCH. Herein, the first and second DMRS sequences may be indicated by a scrambling code identification number n_{SCID}. Alternatively, n_{SCID} may also be indicated in other signaling.

Table 1 below illustrates an example of the DMRS configuration information, wherein different values of the field “Ports-SCID-Number of Layers” indicate different DMRS configuration information.

TABLE 1
Examples of DMRS configuration information

| 1 codeword: codeword 0 enabled, | | 1 codeword: codeword 0 | |
|---|---|---|---|
| codeword 1 disabled | | enabled, codeword 1 disabled | |
| Field | | Field | |
| value | DMRS configuration | value | DMRS configuration |
| 0 | Layer 1, first DMRS | 0 | Layer 2, first DMRS |
| | configuration information: | | configuration |
| | (port 7, n_{SCID} = 0), second | | information: (ports 7-8, |
| | DMRS configuration | | n_{SCID} = 0), second |
| | information: (port 8, | | DMRS configuration |
| | n_{SCID} = 1) | | information: (ports 9-10, |
| | | | n_{SCID} = 1) |
| 1 | Layer 1, first DMRS | 1 | Layer 2, first DMRS |
| | configuration information: | | configuration |
| | (port 7, n_{SCID} = 0), second | | information: (ports 7-8, |
| | DMRS configuration | | n_{SCID} = 1), second |
| | information: (port 8, | | DMRS configuration |
| | n_{SCID} = 1) | | information: (ports 9-10, |
| | | | n_{SCID} = 0) |
| 2 | Layer 1, first DMRS | 2 | Layer 3, first DMRS |
| | configuration information: | | configuration |
| | (port 9, n_{SCID} = 0), second | | information: (ports 7-9, |
| | DMRS configuration | | n_{SCID} = 0), second DMRS |
| | information: (port 10, | | configuration |
| | n_{SCID} = 1) | | information: (ports 10-12, |
| | | | n_{SCID} = 1) |
| 3 | Layer 1, first DMRS | 3 | Layer 4, first DMRS |
| | configuration information: | | configuration |
| | (port 9, n_{SCID} = 0), second | | information: (ports 7-10, |
| | DMRS configuration | | n_{SCID} = 0), second DMRS |
| | information: (port 10, | | configuration |
| | n_{SCID} = 1) | | information: (ports 11-14, |
| | | | n_{SCID} = 1) |
| 4 | Layer 2, first DMRS | 4 | Layer 5, first DMRS |
| | configuration information: | | configuration |
| | (ports 7-8, n_{SCID} = 0), second | | information: (ports 7-11, |
| | DMRS configuration | | n_{SCID} = 0), second |
| | information: (ports 9-10, | | DMRS configuration |
| | n_{SCID} = 1) | | information: (ports 12-16, |
| | | | n_{SCID} = 1) |
| 5 | Layer 3, first DMRS | 5 | Layer 6, first DMRS |
| | configuration information: | | configuration |
| | (ports 7-9, n_{SCID} = 0), | | information: (ports 7-12, |
| | second DMRS configuration | | n_{SCID} = 0), second DMRS |
| | information: (ports 10-12, | | configuration |
| | n_{SCID} = 1) | | information: (ports 13-18, |
| | | | n_{SCID} = 1) |
| 6 | Layer 4, first DMRS | 6 | Layer 7, first DMRS |
| | configuration information: | | configuration |
| | (ports 7-10, n_{SCID} = 0), | | information: (ports 7-13, |
| | second DMRS configuration | | n_{SCID} = 0), second DMRS |
| | information: (ports 11-14, | | configuration |
| | n_{SCID} = 1) | | information: (ports 13-19, |
| | | | n_{SCID} = 1) |
| 7 | Reserved | 7 | Layer 8, first DMRS |
| | | | configuration |
| | | | information: (ports 7-14, |
| | | | n_{SCID} = 0), second DMRS |
| | | | configuration |
| | | | information: (ports 15-22, |
| | | | n_{SCID} = 1) |

Table 2 below illustrates another example of the DMRS configuration information, wherein different values of the field “Ports-SCID-Number of Layers” indicate different DMRS configuration information.

TABLE 2
Examples of DMRS configuration information

| 1 codeword: codeword 0 enabled, | | 1 codeword: codeword 0 enabled, | |
|---|---|---|---|
| codeword 1 disabled | | codeword 1 disabled | |
| Field | | Field | |
| value | DMRS configuration | value | DMRS configuration |
| 0 | Layer 1, first DMRS | 0 | Layer 2, first DMRS |
| | configuration information: | | configuration |
| | (port 7), second DMRS | | information: (ports 7-8), |
| | configuration information: | | second DMRS configuration |
| | (port 8) | | information: (ports 9-10) |
| 1 | Layer 1, first DMRS | 1 | Layer 2, first DMRS |
| | configuration information: | | configuration |
| | (port 7), second DMRS | | information: (ports 7-8), |
| | configuration information: | | second DMRS configuration |
| | (port 8) | | information: (ports 9-10) |
| 2 | Layer 1, first DMRS | 2 | Layer 3, first DMRS |
| | configuration information: | | configuration |
| | (port 9), second DMRS | | information: (ports 7-9), |
| | configuration information: | | second DMRS configuration |
| | (port 10) | | information: (ports 10-12) |
| 3 | Layer 1, first DMRS | 3 | Layer 4, first DMRS |
| | configuration information: | | configuration |
| | (port 9), second DMRS | | information: (ports 7-10), |
| | configuration information: | | second DMRS configuration |
| | (port 10) | | information: (ports 11-14) |
| 4 | Layer 2, first DMRS | 4 | Layer 5, first DMRS |
| | configuration information: | | configuration |
| | (ports 7-8), second | | information: (Ports 7-11), |
| | DMRS configuration | | second DMRS configuration |
| | information: (ports 9-10, | | information: (ports 12-16) |
| | n_{SCID} = 1) | | |
| 5 | Layer 3, first DMRS | 5 | Layer 6, first DMRS |
| | configuration information: | | configuration |
| | (ports 7-9, n_{SCID} = 0), | | information: (ports 7-12), |
| | second DMRS configuration | | second DMRS configuration |
| | information: (ports 10-12, | | information: (ports 13-18) |
| | n_{SCID} = 1) | | |
| 6 | Layer 4, first DMRS | 6 | Layer 7, first DMRS |
| | configuration information: | | configuration |
| | (ports 7-10, n_{SCID} = 0), | | information: (ports 7-13), |
| | second DMRS configuration | | second DMRS configuration |
| | information: (ports 11-14, | | information: (ports 13-19) |
| | n_{SCID} = 1) | | |
| 7 | Reserved | 7 | Layer 8, first DMRS |
| | | | configuration |
| | | | information: (ports 7-14), |
| | | | second DMRS configuration |
| | | | information: (ports 15-22) |

In another example, the antenna port related to the first PDSCH and the antenna port related to the second PDSCH are indicated in a bitmap format in the DCI.

For example, the length of a bitmap X in the first DMRS configuration information may be 4 bits, and available antenna ports are those numbered 7, 8, 9, and 10, which may have the following meanings:
X=0001 indicates that the antenna port related to the first PDSCH is an antenna port numbered 10.
X=0001 indicates that the antenna port related to the first PDSCH is an antenna port numbered 10.
X=0010 indicates that the antenna port related to the first PDSCH is an antenna port numbered 9.
X=0011 indicates that the DMRS antenna ports related to the PDSCH of the user are antenna ports numbered 9 and 10.
X=0100 indicates that the antenna port related to the first PDSCH is an antenna port numbered 8.
X=0101 indicates that the antenna ports related to the first PDSCH are antenna ports numbered 8 and 10.
X=0110 indicates that the antenna ports related to the first PDSCH are antenna ports numbered 8 and 9.
X=0111 indicates that the antenna ports related to the first PDSCH are antenna ports numbered 8, 9, and 10.
X=1000 indicates that the antenna port related to the first PDSCH is an antenna port numbered 7.
X=1001 indicates that the antenna ports related to the first PDSCH are antenna ports numbered 7 and 10.
X=1010 indicates that the antenna ports related to the first PDSCH are antenna ports numbered 7 and 9.
X=1011 indicates that the antenna ports related to the first PDSCH are antenna ports numbered 7, 9, and 10.
X=1100 indicates that the antenna ports related to the first PDSCH are antenna ports numbered 7 and 8.
X=1101 indicates that the antenna ports related to the first PDSCH are antenna ports numbered 7, 8 and 10.
X=1110 indicates that the antenna ports related to the first PDSCH are antenna ports numbered 7, 8, and 9.
X=1111 indicates that the antenna ports related to the first PDSCH are antenna ports numbered 7, 8, 9, and 10.
X=0000 indicates that no antenna port is used.

The length of a bitmap Y in the second DMRS configuration information may be 4 bits, and available antenna ports are those numbered 7, 8, 9, and 10, which may have the following meanings:
Y=0001 indicates that the antenna port related to the second PDSCH is an antenna port numbered 10.
Y=0001 indicates that the antenna port related to the second PDSCH is an antenna port numbered 10.
Y=0010 indicates that the antenna port related to the second PDSCH is an antenna port numbered 9.
Y=0011 indicates that the antenna ports related to the second PDSCH are antenna ports numbered 9 and 10.
Y=0100 indicates that the antenna port related to the second PDSCH is an antenna port numbered 8.
Y=0101 indicates that the antenna ports related to the second PDSCH are antenna ports numbered 8 and 10.
Y=0110 indicates that the antenna ports related to the second PDSCH are antenna ports numbered 8 and 9.
Y=0111 indicates that the antenna ports related to the second PDSCH are antenna ports numbered 8, 9, and 10.
Y=1000 indicates that the antenna port related to the second PDSCH is an antenna port numbered 7.
Y=1001 indicates that the antenna ports related to the second PDSCH are antenna ports numbered 7 and 10.
Y=1010 indicates that the antenna ports related to the second PDSCH are antenna ports numbered 7 and 9.
Y=1011 indicates that the antenna ports related to the second PDSCH are antenna ports numbered 7, 9, and 10.
Y=1100 indicates that the antenna ports related to the second PDSCH are antenna ports numbered 7 and 8.
Y=1101 indicates that the antenna ports related to the second PDSCH are antenna ports numbered 7, 8, and 10.
Y=1110 indicates that the antenna ports related to the second PDSCH are antenna ports numbered 7, 8, and 9.
Y=1111 indicates that the antenna ports related to the second PDSCH are antenna ports numbered 7, 8, 9, and 10.
Y=0000 indicates that no antenna port is used.

In an alternative embodiment, the first DMRS configuration information comprises an indicator regarding a first plurality of antenna port groups related to the first DMRS configuration information sent in RRC signaling, and an indicator regarding an antenna port group related to the first PDSCH in the first plurality of antenna port groups sent in the DCI; and the second DMRS configuration information comprises an indicator regarding a second plurality of antenna port groups related to the second DMRS configuration information sent in the RRC signaling, and an indicator regarding an antenna port group related to the second PDSCH in the second plurality of antenna port groups sent in the DCI.

As an example, in the case of 8 antenna ports, the 8 antenna ports are numbered 1, 2, 3, 4, 5, 6, 7, and 8 respectively, wherein two antenna ports may form one antenna port group as follows:
Antenna port group 1: antenna port 1 and antenna port 2.
Antenna port group 2: antenna port 3 and antenna port 4.
Antenna port group 3: antenna port 5 and antenna port 6.
Antenna port group 4: antenna port 7 and antenna port 8.

The indicator regarding the first plurality of antenna port groups related to the first DMRS configuration information is indicated in the RRC signaling. For example, if the RRC signaling comprises the following information:
RRC configuration:
DMRS-antenna-group: {n1, n2, n4}
   it indicates that configurable antenna port groups are the antenna port group 1, the antenna port group 2, and the antenna port group 4.

Moreover, in the DCI, a 2-bit parameter “Antenna_port_indicator_N-UE” is used to indicate which antenna port group(s) in the configurable antenna port groups indicated by the RRC signaling are used for the first PDSCH, i.e., indicating antenna port groups related to the first PDSCH in the first plurality of antenna port groups, as shown in Table 3 below:

TABLE 3
Examples of antenna port group indicator in DCI

| Antenna_port_indicator_N-UE | Antenna port group |
|---|---|
| 00 | Antenna port group 1 |
| 01 | Antenna port group 2 |
| 10 | Antenna port group 3 |
| 11 | Antenna port group 4 |

Antenna_port_indicator_N-UE = 00 indicates that the antenna port group related to the first PDSCH is the antenna port group 1.
Antenna_port_indicator_N-UE = 01 indicates that the antenna port group related to the first PDSCH is the antenna port group 2.
Antenna_port_indicator_N-UE = 10 indicates that the antenna port group related to the first PDSCH is the antenna port group 3.
Antenna_port_indicator_N-UE = 11 indicates that the antenna port group related to the first PDSCH is the antenna port group 4.

Moreover, as an example, in the case of 8 antenna ports, the 8 antenna ports are numbered 1, 2, 3, 4, 5, 6, 7, and 8 respectively. Two antenna ports may form one antenna port group as follows:
Antenna port group 1: antenna port 1 and antenna port 2.
Antenna port group 2: antenna port 3 and antenna port 4.
Antenna port group 3: antenna port 5 and antenna port 6.
Antenna port group 4: antenna port 7 and antenna port 8.

An indicator regarding the second plurality of antenna port groups associated with the second DMRS configuration information is indicated in the RRC signaling. For example, if the RRC signaling comprises the following information:
RRC configuration:
DMRS-antenna-group: {n1, n2, n4}
   it indicates that configurable antenna port groups are the antenna port group 1, the antenna port group 2, and the antenna port group 4.

Moreover, in the DCI, a 2-bit parameter “Antenna_port_indicator_F-UE” is used to indicate which antenna port group(s) in the configurable antenna port groups indicated by the RRC signaling are used for the second PDSCH, i.e., indicate an antenna port group related to the second PDSCH in the second plurality of antenna port groups, as shown in Table 4 below:

TABLE 4
Examples of antenna port group indicator in DCI

| Antenna_port_indicator_F-UE | Antenna port group |
|---|---|
| 00 | Antenna port group 1 |
| 01 | Antenna port group 2 |
| 10 | Antenna port group 3 |
| 11 | Antenna port group 4 |

Antenna_port_indicator_F-UE = 00 indicates that the antenna port group related to the second PDSCH is the antenna port group 1.
Antenna_port_indicator_F-UE = 01 indicates that the antenna port group related to the second PDSCH is the antenna port group 2.
Antenna_port_indicator_F-UE = 10 indicates that the antenna port group related to the second PDSCH is the antenna port group 3.
Antenna_port_indicator_F-UE = 11 indicates that the antenna port group related to the second PDSCH is the antenna port group 4.

FIG. 2 is a flowchart of a method 200 for use in the base station according to an embodiment of the present invention. It should be noted that all features described in conjunction with the embodiments of the above base station 100 are also applicable to method embodiments below. The method 200 may be performed by the above base station 100, and comprises the following steps.

In step S210, first DMRS configuration information associated with a first PDSCH for the UE is generated.

In step S220, second DMRS configuration information associated with a second PDSCH for another UE is generated, the second PDSCH overlapping with the first PDSCH.

In step S230, the first DMRS configuration information and the second DMRS configuration information are sent to the UE.

In one embodiment, the first DMRS configuration information and the second DMRS configuration information are sent in DCI.

In one embodiment, the first DMRS configuration information and the second DMRS configuration information are included in a field of “Ports-SCID-Number of Layers” of the DCI.

In one embodiment, the first DMRS configuration information indicates an antenna port related to the first PDSCH; and the second DMRS configuration information indicates an antenna port related to the second PDSCH.

In one embodiment, the first DMRS configuration information further indicates a first DMRS sequence related to the first PDSCH; and the second DMRS configuration information further indicates a second DMRS sequence related to the second PDSCH.

In one embodiment, the antenna port related to the first PDSCH and the antenna port related to the second PDSCH are indicated in a bitmap format.

In one embodiment, the first DMRS configuration information comprises an indicator regarding a first plurality of antenna port groups related to the first DMRS configuration information sent in RRC signaling, and an indicator regarding an antenna port group related to the first PDSCH in the first plurality of antenna port groups sent in the DCI; and the second DMRS configuration information comprises an indicator regarding a second plurality of antenna port groups related to the second DMRS configuration information sent in the RRC signaling, and an indicator regarding an antenna port group related to the second PDSCH in the second plurality of antenna port groups sent in the DCI.

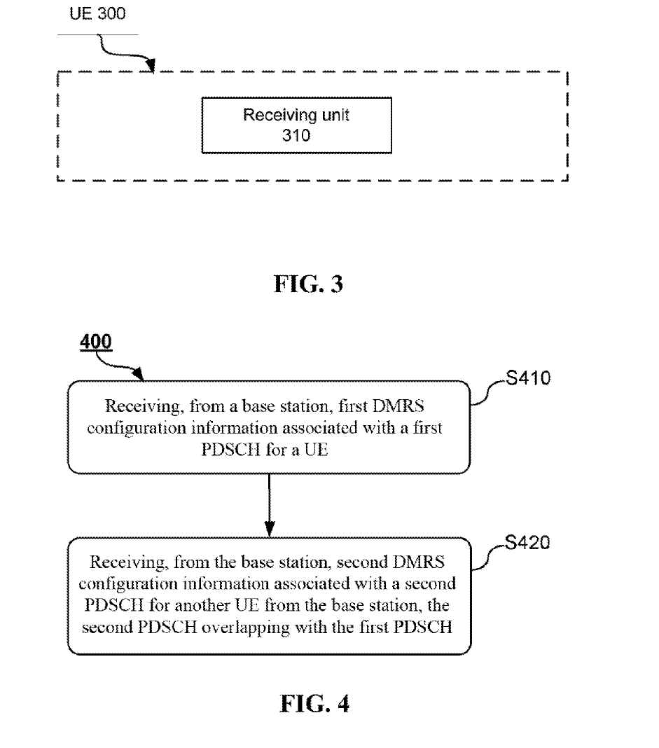

FIG. 3 illustrates a block diagram of a UE 300 according to an embodiment of the present invention. As shown in the figure, the UE 300 comprises a receiving unit 310. One skilled in the art will understand that the UE 300 further comprises other function units necessary to realize functions thereof, such as various processors, memories and the like.

The receiving unit 310 is configured to receive first DMRS configuration information associated with a first PDSCH for the UE from a base station, and receive second DMRS configuration information associated with a second PDSCH for another UE from the base station, the second PDSCH overlapping with the first PDSCH.

In one embodiment, the first DMRS configuration information and the second DMRS configuration information are received in DCI.

In one embodiment, the first DMRS configuration information and the second DMRS configuration information are included in a field of “Ports-SCID-Number of Layers” of the DCI.

In one embodiment, the first DMRS configuration information indicates an antenna port related to the first PDSCH; and the second DMRS configuration information indicates an antenna port related to the second PDSCH.

In one embodiment, the first DMRS configuration information further indicates a first DMRS sequence related to the first PDSCH; and the second DMRS configuration information further indicates a second DMRS sequence related to the second PDSCH.

In one embodiment, the antenna port related to the first PDSCH and the antenna port related to the second PDSCH are indicated in a bitmap format.

In one embodiment, the first DMRS configuration information comprises an indicator regarding a first plurality of antenna port groups related to the first DMRS configuration information sent in RRC signaling, and an indicator regarding an antenna port group related to the first PDSCH in the first plurality of antenna port groups sent in the DCI; and the second DMRS configuration information comprises an indicator regarding a second plurality of antenna port groups related to the second DMRS configuration information sent in the RRC signaling, and an indicator regarding an antenna port group related to the second PDSCH in the second plurality of antenna port groups sent in the DCI.

FIG. 4 is a flowchart of a method 400 for use in a UE according to an embodiment of the present invention. It should be noted that all features described in conjunction with the embodiments of the above UE 300 are also applicable to method embodiments below. The method 400 may be performed by the above UE 300, and comprises the following steps.

In step S410, first DMRS configuration information associated with a first PDSCH for the UE is received from the base station.

In step 420, second DMRS configuration information associated with a second PDSCH for another UE is received from the base station, the second PDSCH overlapping with the first PDSCH.

In one embodiment, the first DMRS configuration information and the second DMRS configuration information are received in DCI.

In one embodiment, the first DMRS configuration information and the second DMRS configuration information are included in a field of “Ports-SCID-Number of Layers” of the DCI.

In one embodiment, the first DMRS configuration information indicates an antenna port related to the first PDSCH; and the second DMRS configuration information indicates an antenna port related to the second PDSCH.

In one embodiment, the first DMRS configuration information further indicates a first DMRS sequence related to the first PDSCH; and the second DMRS configuration information further indicates a second DMRS sequence related to the second PDSCH.

In one embodiment, the antenna port related to the first PDSCH and the antenna port related to the second PDSCH are indicated in a bitmap format.

In one embodiment, the first DMRS configuration information comprises an indicator regarding a first plurality of antenna port groups related to the first DMRS configuration information sent in RRC signaling, and an indicator regarding an antenna port group related to the first PDSCH in the first plurality of antenna port groups sent in the DCI; and the second DMRS configuration information comprises an indicator regarding a second plurality of antenna port groups related to the second DMRS configuration information sent in the RRC signaling, and an indicator regarding an antenna port group related to the second PDSCH in the second plurality of antenna port groups sent in the DCI.

The above-described UE 300 and the method 400 for use in the UE correspond to the above-described base station 100 and the method 200 for use in the base station respectively. Therefore, respective examples described in conjunction with the base station 100 and the method 200 are also applicable to the UE 300 and the method 400.

According to the embodiment of the present invention, the base station generates the first DMRS configuration information associated with the first PDSCH for the UE and the second DMRS configuration information associated with the second PDSCH for another UE, and the second PDSCH overlaps with the first PDSCH; and sends to the UE the first DMRS configuration information and the second DMRS configuration information. Therefore, the UE is enabled to know DMRS configurations associated with its own PDSCH and its PDSCH on which interference cancellation needs to be performed.

The methods and related equipment according to the present invention have been described above in conjunction with preferred embodiments. It should be understood by a person skilled in the art that the methods illustrated above are only exemplary. The methods of the present invention are not limited to the steps or sequences illustrated above. The network node and user equipment illustrated above may comprise more modules. For example, the network node and user equipment may further comprise modules which can be developed or will be developed in future to be applied to a base station, an MME or a UE, and the like. Various identifiers shown above are only exemplary, and are not meant for limiting the present invention. The present invention is not limited to specific information elements serving as examples of these identifiers. A person skilled in the art can make various alterations and modifications according to the teachings of the illustrated embodiments.

It is to be understood that the above-described embodiments of the present invention may be implemented by software or by hardware or by a combination of both software and hardware. For example, various components inside the base station and the UE in the above-described embodiments may be implemented through various devices, which include, but are not limited to: analog circuit devices, digital circuit devices, digital signal processing (DSP) circuits, programmable processors, application specific integrated circuits (ASICs), field programmable gate arrays (FPGAs), programmable logic devices (CPLDs), and the like.

In the present application, “a base station” refers to a mobile communication data and control switching center provided with a larger transmitting power and a wider coverage area and including functions such as resource allocation and scheduling, and data receiving and sending. A “user equipment” refers to a user mobile terminal, for example, a terminal device that can wirelessly communicate with a base station or a micro base station, such as a mobile phone and a notebook.

In addition, the embodiments of the present invention disclosed herein may be implemented on a computer program product. More specifically, the computer program product is a product provided with a computer-readable medium having computer program logic encoded thereon. When executed on a computing device, the computer program logic provides related operations to implement the above-described technical solutions of the present invention. When executed on at least one processor of a computing system, the computer program logic enables the processor to perform the operations (methods) described in the embodiments of the invention. Such an arrangement of the present invention is typically provided as software, codes and/or other data structures disposed on or encoded on a computer-readable medium such as an optical medium (eg, a CD-ROM), a floppy disk or a hard disk, or other media such as firmware or microcode on one or more ROM or RAM or PROM chips, or downloadable software images and shared databases in one or more modules etc. Software or firmware or such configuration may be installed on a computing device such that one or more processors in the computing device perform the technical solutions described in the embodiments of the present invention.

Moreover, each function module or various features of the base station device and the terminal device used in each embodiment described above may be implemented or executed by a circuit, which is generally one or more integrated circuits. Circuits which are designed to perform various functions described in this specification may include general-purpose processors, digital signal processors (DSPs), application specific integrated circuits (ASICs) or general-purpose integrated circuits, field programmable gate arrays (FPGAs), or other programmable logic devices, discrete gates or transistor logic, or discrete hardware components, or any combination of the above-described devices. The general purpose processor may be a microprocessor, or the processor may be an existing processor, a controller, a microcontroller, or a state machine. The above-described general-purpose processor or each circuit may be configured by a digital circuit or may be configured by a logic circuit. Furthermore, integrated circuits obtained by an advanced technology can also be used in the present invention, if the advanced technology capable of replacing current integrated circuits appears due to the advancement of semiconductor technology.

While the present invention has been illustrated in combination with the preferred embodiments of the present invention, it will be understood by those skilled in the art that various modifications, substitutions, and alterations may be made to the present invention without departing from the spirit and scope of the invention. Therefore, the present invention should not be limited by the above-described embodiments, but should be defined by the appended claims and their equivalents.

1. A method for use in a base station for indicating to a UE a demodulation reference signal (DMRS) configuration, the method comprising:
generating first DMRS configuration information associated with a first physical downlink shared channel (PDSCH) for the UE;
generating second DMRS configuration information associated with a second PDSCH for another UE, the second PDSCH overlapping with the first PDSCH;
and sending to the UE the first DMRS configuration information and the second DMRS configuration information.

2. The method according to claim 1, wherein the first DMRS configuration information and the second DMRS configuration information are sent in downlink control information (DCI).

3. The method according to claim 2, wherein the first DMRS configuration information and the second DMRS configuration information are comprised in a field of “Ports Scrambling Code Identification Number of Layers (Ports-SCID-Number of Layers)” of the DCI.

4. The method according to claim 2, wherein the first DMRS configuration information indicates an antenna port related to the first PDSCH; and the second DMRS configuration information indicates an antenna port related to the second PDSCH.

5. The method according to claim 4, wherein the first DMRS configuration information further indicates a first DMRS sequence related to the first PDSCH; and the second DMRS configuration information further indicates a second DMRS sequence related to the second PDSCH.

6. The method according to claim 4, wherein the antenna port related to the first PDSCH and the antenna port related to the second PDSCH are indicated in a bitmap format.

7. The method according to claim 1, wherein
the first DMRS configuration information comprises an indicator regarding a first plurality of antenna port groups related to the first DMRS configuration information sent in radio resource control (RRC) signaling, and an indicator regarding an antenna port group in the first plurality of antenna port groups related to the first PDSCH sent in the DCI; and
the second DMRS configuration information comprises an indicator regarding a second plurality of antenna port groups related to the second DMRS configuration information sent in the RRC signaling, and an indicator regarding an antenna port group related to the second PDSCH in the second plurality of antenna port groups sent in the DCI.

8. A base station for indicating to a UE a DMRS configuration, the base station comprising:
a generating unit, used for generating first DMRS configuration information associated with a first PDSCH for the UE, and generating second DMRS configuration information associated with a second PDSCH for another UE, the second PDSCH overlapping with the first PDSCH; and
a sending unit, used for sending to the UE the first DMRS configuration information and the second DMRS configuration information.

9. The base station according to claim 8, wherein the first DMRS configuration information and the second DMRS configuration information are sent in DCI.

10. The base station according to claim 9, wherein the first DMRS configuration information and the second DMRS configuration information are comprised in a field of “Ports-SCID-Number of Layers” of the DCI.

11. The base station according to claim 9, wherein the first DMRS configuration information indicates an antenna port related to the first PDSCH; and the second DMRS configuration information indicates an antenna port related to the second PDSCH.

12. The base station according to claim 11, wherein the first DMRS configuration information further indicates a first DMRS sequence related to the first PDSCH; and the second DMRS configuration information further indicates a second DMRS sequence related to the second PDSCH.

13. The base station according to claim 11, wherein the antenna port related to the first PDSCH and the antenna port related to the second PDSCH are indicated in a bitmap format.

14. The base station according to claim 8, wherein
the first DMRS configuration information comprises an indicator regarding a first plurality of antenna port groups related to the first DMRS configuration information sent in RRC signaling, and an indicator regarding an antenna port group related to the first PDSCH in the first plurality of antenna port groups sent in the DCI; and
the second DMRS configuration information comprises an indicator regarding a second plurality of antenna port groups related to the second DMRS configuration information sent in the RRC signaling, and an indicator regarding an antenna port group related to the second PDSCH in the second plurality of antenna port groups sent in the DCI.

15. A method for use in a UE for acquiring a DMRS configuration, comprising:
receiving, from a base station, first DMRS configuration information associated with a first PDSCH for the UE; and
receiving, from the base station, second DMRS configuration information associated with a second PDSCH for another UE, the second PDSCH overlapping with the first PDSCH.

16. The method according to claim 15, wherein the first DMRS configuration information and the second DMRS configuration information are received in DCI.

17. The method according to claim 16, wherein the first DMRS configuration information and the second DMRS configuration information are comprised in a field of “Ports-SCID-Number of Layers” of the DCI.

18. The method according to claim 16, wherein the first DMRS configuration information indicates an antenna port related to the first PDSCH; and the second DMRS configuration information indicates an antenna port related to the second PDSCH.

19. The method according to claim 18, wherein the first DMRS configuration information further indicates a first DMRS sequence related to the first PDSCH; and the second DMRS configuration information further indicates a second DMRS sequence related to the second PDSCH.

20. The method according to claim 18, wherein the antenna port related to the first PDSCH and the antenna port related to the second PDSCH are indicated in a bitmap format.

21. The method according to claim 15, wherein
the first DMRS configuration information comprises an indicator regarding a first plurality of antenna port groups related to the first DMRS configuration information sent in RRC signaling, and an indicator regarding an antenna port group related to the first PDSCH in the first plurality of antenna port groups sent in the DCI; and
the second DMRS configuration information comprises an indicator regarding a second plurality of antenna port groups related to the second DMRS configuration information sent in the RRC signaling, and an indicator regarding an antenna port group related to the second PDSCH in the second plurality of antenna port groups sent in the DCI.

22. A UE for acquiring a DMRS configuration, comprising:
a receiving unit, configured to receive, from a base station, first DMRS configuration information associated with a first PDSCH for the UE; and receive, from the base station, second DMRS configuration information associated with a second PDSCH for another UE, the second PDSCH overlapping with the first PDSCH.

23. The UE according to claim 22, wherein the first DMRS configuration information and the second DMRS configuration information are received in DCI.

24. The UE according to claim 23, wherein the first DMRS configuration information and the second DMRS configuration information are comprised in a field of “Ports-SCID-Number of Layers” of the DCI.

25. The UE according to claim 23, wherein the first DMRS configuration information indicates an antenna port related to the first PDSCH; and the second DMRS configuration information indicates an antenna port related to the second PDSCH.

26. The UE according to claim 25, wherein the first DMRS configuration information further indicates a first DMRS sequence related to the first PDSCH; and the second DMRS configuration information further indicates a second DMRS sequence related to the second PDSCH.

27. The UE according to claim 25, wherein the antenna port related to the first PDSCH and the antenna port related to the second PDSCH are indicated in a bitmap format.

28. The UE according to claim 22, wherein
the first DMRS configuration information comprises an indicator regarding a first plurality of antenna port groups related to the first DMRS configuration information sent in RRC signaling, and an indicator regarding an antenna port group related to the first PDSCH in the first plurality of antenna port groups sent in the DCI; and
the second DMRS configuration information comprises an indicator regarding a second plurality of antenna port groups related to the second DMRS configuration information sent in the RRC signaling, and an indicator regarding an antenna port group related to the second PDSCH in the second plurality of antenna port groups sent in the DCI.
